(19) United States
(12) Patent Application Publication
(10) Pub. No.: US 2019/0077201 A1
(43) Pub. Date: Mar. 14, 2019

(54) PNEUMATIC TIRE AND TIRE VULCANIZING MOLD

(71) Applicant: TOYO TIRE & RUBBER CO., LTD., Itami-shi (JP)

(72) Inventor: Keiki Orii, Itami-shi (JP)

(73) Assignee: TOYO TIRE & RUBBER CO., LTD., Itami-shi (JP)

(21) Appl. No.: 16/110,321

(22) Filed: Aug. 23, 2018

(30) Foreign Application Priority Data
Sep. 12, 2017 (JP) 2017-174609

(51) Int. Cl. B60C 11/13; B29D 30/06

(52) U.S. Cl. CPC B60C 11/1369; B60C 11/1307; B29D 2030/0612; B60C 2011/133; B29D 30/0606

(57) ABSTRACT

A pneumatic tire including: a circumferential groove partitions a contact patch; and a protrusion that protrudes from a base of the circumferential groove and that interconnects two groove sidewalls at either side in a groove width direction of the protrusion. As seen in plan view, at least one of the two groove sidewalls at either side in the groove width direction of the protrusion has a first region that is adjacent to the protrusion, second regions that are present to either side in the groove long direction of the first region, and a first chamfered region that serves as beveling and that is formed at the first region. Presence of the first chamfered region causes an edge where the contact patch and the groove sidewall of the first region intersect to be more relieved than an edge where the contact patch and the groove sidewall of the second region intersect.

### BACKGROUND OF THE INVENTION

### Field of the Invention

The present disclosure relates to a pneumatic tire in which a protrusion is formed at the base of a circumferential groove extending in the tire circumferential direction and to a tire vulcanizing mold.

### Description of the Related Art

In pneumatic tires, so as to allow one to know when it is time to replace a tire due to wear, arranged in the tire circumferential direction there are a plurality of wear indicators that protrude from base(s) of major groove(s) which extend in the tire circumferential direction. The tread region of a pneumatic tire is ordinarily formed so as to be of more or less constant thickness. However, to form the wear indicator, more rubber has been required in the vicinity of the wear indicator than at other locations, and where flow of rubber has been poor due to there having been an insufficient amount of rubber, there has been the problem that it sometimes occurs that air is trapped within the wear indicator itself and/or the surrounding area.

Japanese Patent Application Publication Kokai No. 2010-234559, in the context of a tire in which a wear indicator (protrusion) for indicating when it is time to replace the tire due to wear of the tire is formed at the base of a circumferential groove, discloses providing a recess at a circumferential groove side face, and filling the wear indicator with the rubber corresponding to said recess, to eliminate rubber insufficiency at the wear indicator. However, because the recess at the circumferential groove side face presents an opening to the contact patch, it impairs visual attractiveness.

It is believed that such problems are not limited to wear indicators provided at major grooves, a similar problem also being present, for example, at the structure indicated in Japanese Patent Application Publication Kokai No. 2003-251632. This example is such that by providing concavity or concavities at the mating surface of the mold, the tire is made to have a structure in which protrusion(s) are formed not only at major groove(s) but also at those circumferential groove(s) which extend in the tire circumferential direction but which are not major groove(s).

### SUMMARY OF INVENTION

The present disclosure was conceived in view of such problems, it being an object thereof to provide a pneumatic tire permitting reduction in trapped air without impairing visual attractiveness, and a mold for molding a tire.

According to the present disclosure, there is provided a pneumatic tire comprising:

a circumferential groove that extends in a tire circumferential direction and that partitions a contact patch; and

a protrusion that protrudes from a base of the circumferential groove and that interconnects two groove sidewalls at either side in a groove width direction of the protrusion;

wherein as seen in plan view, at least one of the two groove sidewalls at either side in the groove width direction of the protrusion has a first region that is adjacent to the protrusion, second regions that are present to either side in the groove long direction of the first region, and a first chamfered region that serves as beveling and that is formed at the first region; and

presence of the first chamfered region causes an edge where the contact patch and the groove sidewall of the first region intersect to be more relieved than an edge where the contact patch and the groove sidewall of the second region intersect.

Thus, relieving by first chamfered region serving as beveling makes it possible for the excess rubber to be used for formation of protrusion, and makes it possible to reduce occurrence of trapped air due to insufficiency in the amount of rubber at protrusion itself and/or the region surrounding protrusion. Moreover, because first chamfered region constitutes beveling of edge, contact patch shape being unaltered, it is possible to avoid impairment of visual attractiveness as compared with the situation that exists with slit(s) that present opening(s) to contact patch.

### BRIEF DESCRIPTION OF DRAWINGS

FIG. 1 Perspective view showing shape of region surrounding protrusion at circumferential groove in accordance with a first embodiment, as well as sectional drawing taken along section A-A, and sectional drawing taken along section B-B.

FIG. 2A Plan view showing shape of region surrounding protrusion at circumferential groove in accordance with the first embodiment.

FIG. 2B Plan view showing a variation on the first embodiment

FIG. 3 Sectional drawing taken along section B-B and showing a variation on the first embodiment.

FIG. 4 Perspective view showing shape of region surrounding protrusion at circumferential groove in accordance with a second embodiment, as well as sectional drawing taken along section A-A, and sectional drawing taken along section B-B.

FIG. 5 Plan view showing shape of region surrounding protrusion at circumferential groove in accordance with the second embodiment.

FIG. 6 Perspective view showing shape of region surrounding protrusion at circumferential groove in accordance with a third embodiment, as well as sectional drawing taken along section A-A, and sectional drawing taken along section B-B.

FIG. 7 Plan view showing shape of region surrounding protrusion at circumferential groove in accordance with the third embodiment.

FIG. 8 Perspective view showing shape of region surrounding protrusion at circumferential groove in accordance with an embodiment in which the first and second embodiments are combined, as well as sectional drawing taken along section A-A, and sectional drawing taken along section B-B.

### DETAILED DESCRIPTION OF THE PREFERRED EMBODIMENTS

### First Embodiment

Below, a first embodiment in accordance with the present disclosure is described. In the drawings. “LD” refers to the long direction of circumferential groove 1, and “WD” refers to the width direction of circumferential groove 1.

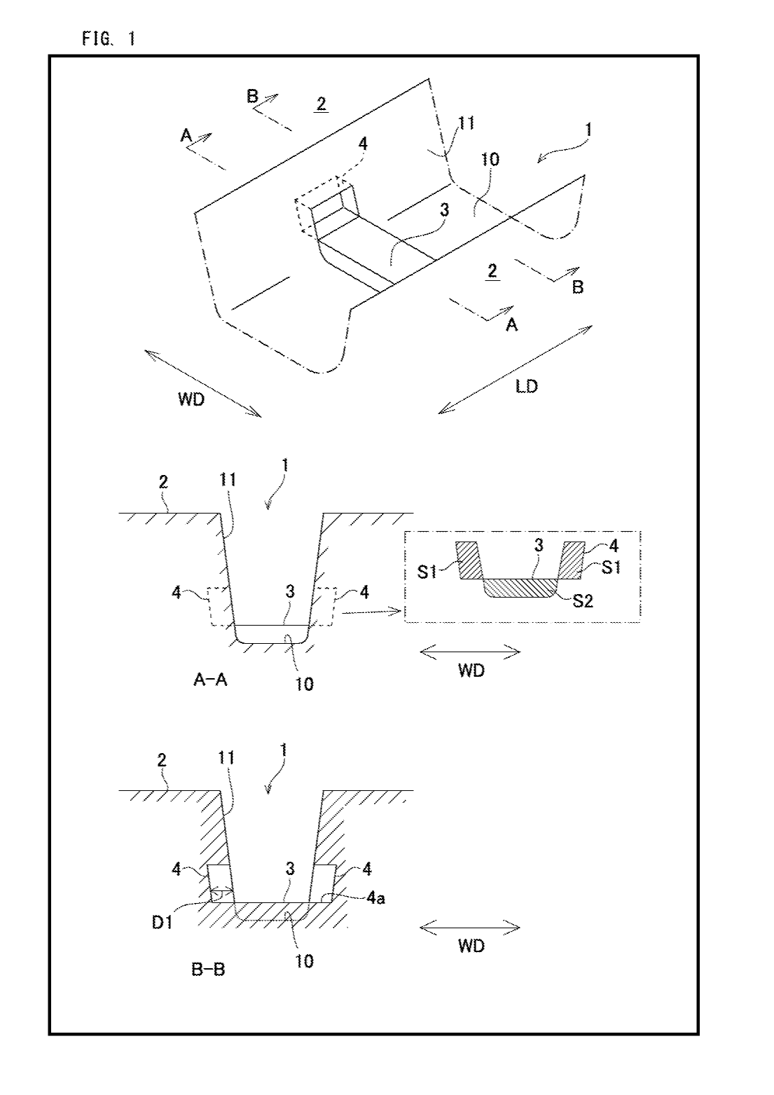

While not shown in the drawings, a pneumatic tire in accordance with the present disclosure, in similar fashion as with an ordinary pneumatic tire, is provided with a pair of bead cores; a carcass that wraps around said bead in toroidal fashion; a belt layer arranged toward the exterior in the tire radial direction from a crown region of said carcass; and a tread region arranged toward the exterior in the tire radial direction from said belt layer. As shown in FIG. 1, formed at said tread region is circumferential groove 1 which extends in at least the tire circumferential direction. In accordance with the present embodiment, a circumferential groove 1 extending in the tire circumferential direction partition contact patch 2 such that lug regions in the form of ribs are formed at the tread region. It is of course possible to adopt a constitution in which lateral grooves extending in the tire width direction are also formed at the tread region, such that lug regions in the form of blocks are formed at the tread region.

As shown in FIG. 1, in accordance with the present embodiment, circumferential groove 1 extending in the tire circumferential direction is a major groove that has a TWI (tire wear indicator) in the form of protrusion 3 which protrudes from base 10. Protrusion 3 mutually connects sidewalls 11 of circumferential groove 1. However, the circumferential groove of the present disclosure is not limited to major grooves but may be present at any groove that has a protrusion which protrudes from the base thereof.

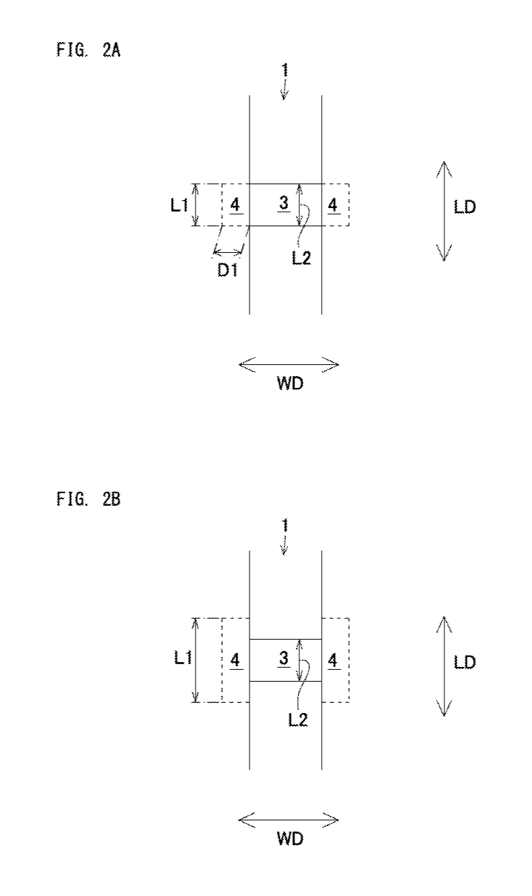

As shown in FIG. 1 and FIGS. 2A and 2B, formed at the two groove sidewalls 11 at either side in the groove width direction WD of protrusion 3 are a pair of mutually facing slits 4. As slits 4 do not extend as far as contact patch 2, being closed at the interior of groove sidewalls 11, they do not present openings to contact patch 2. As shown in FIGS. 2A and 2B, as seen in plan view, length L1 in the groove long direction LD of slit 4 is not less than length L2 in the groove long direction LD of protrusion 3. FIG. 2A shows an example in which length L1 in the groove long direction LD of slit 4 is the same as length L2 in the groove long direction LD of protrusion 3. FIG. 2B shows an example in which length L1 in the groove long direction LD of slit 4 is greater than length L2 in the groove long direction LD of protrusion 3.

If L1<L2, it is thought that, as rubber that is being filled so as to be directed toward protrusion 3 cannot be described as adequate, the effect whereby occurrence of trapped air (i.e., a bare spot) at protrusion 3 itself is reduced will be weakened. L1>L2 is more preferable than L1=L2. If L1>L2, this will make it possible for length D1 of slit 4 in the groove width direction WD of circumferential groove 1 to be made short, making it possible to decrease the tendency for the tire to get stuck during removal from the mold, and making it possible to decrease occurrence of cracking of the tire. Furthermore, if L1>L2, due to formation of slits 4, because there is a tendency for the amount of excess rubber to increase beyond the amount of rubber needed to form protrusion 3, it will be possible to achieve further improvement in the effect whereby trapped air at protrusion 3 itself is reduced.

It is preferred, at a sectional view of a section taken along the groove width direction WD of circumferential groove 1 (shown in FIG. 1), that the sum (S1×2) of the cross-sectional area S1 at each of the pair of slits 4 be not less than the cross-sectional area S2 of protrusion 3. If this condition is satisfied, this will cause the volume of the pair of slits to be not less than the volume of the protrusion. But note that there will of course be occurrence of effect whereby trapped air is suppressed even when the sum (S1×2) of the cross-sectional area S1 at each of the pair of slits 4 is less than the cross-sectional area S2 of protrusion 3.

As shown in FIG. 1, it is preferred that bottom face 4a of slit 4 be at the same depth as, or at a location more shallow than, the top face of protrusion 3. This is because if bottom face 4a of slit 4 is at a location deeper than the top face of protrusion 3, this will make it difficult to remove the tire from the mold and will increase the likelihood that cracking will occur. Furthermore, because when the bottom face 4a of slit 4 is shallower than the top face of protrusion 3, the shallower that it is the weaker will be the effect whereby filling of protrusion 3 with rubber is supplemented, it is preferred that bottom face 4a of slit 4 be coplanar with the top face of protrusion 3.

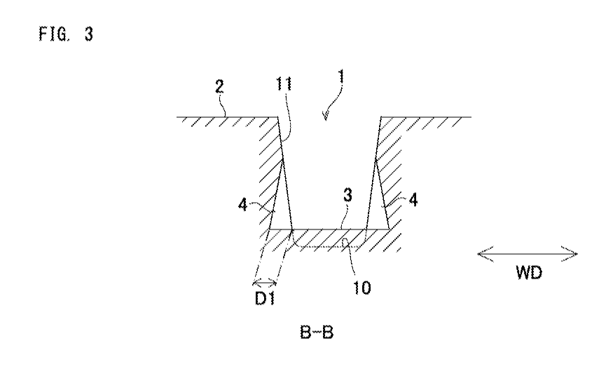

### Variations

Whereas in the example shown in FIG. 1 no chamfering or other such beveling is provided at the edges where groove sidewalls 11 intersect contact patch 2, at least one of the two edges at either side of circumferential groove 1 may be provided with chamfering.

Whereas as shown in FIG. 1 length D1 of slit 4 in the groove width direction WD of circumferential groove 1 is constant in accordance with the present embodiment, there is no limitation with respect thereto. For example as shown in FIG. 3, slit 4 may be formed such that length D1 of slit 4 in the groove width direction WD of circumferential groove 1 increases as one proceeds from the shallow end of circumferential groove 1 to the deep end thereof. By so doing, this will make it possible to decrease the tendency for occurrence of snagging on slit 4 during removal of the tire from the mold, and make it possible to decrease occurrence of cracking.

There is no limitation with respect to the cross-sectional shape of slit 4, various modifications with respect thereto being possible. Rectangular, triangular, partially arcuate, and so forth may be cited as examples.

### Second Embodiment

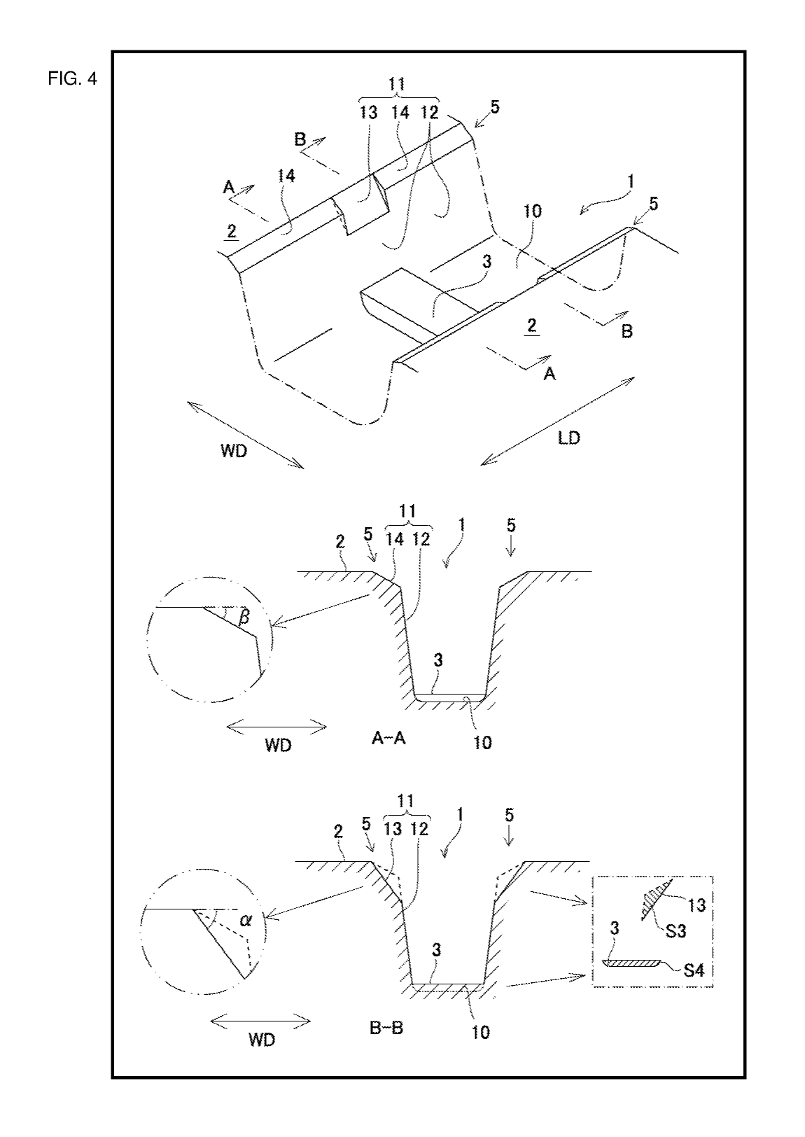

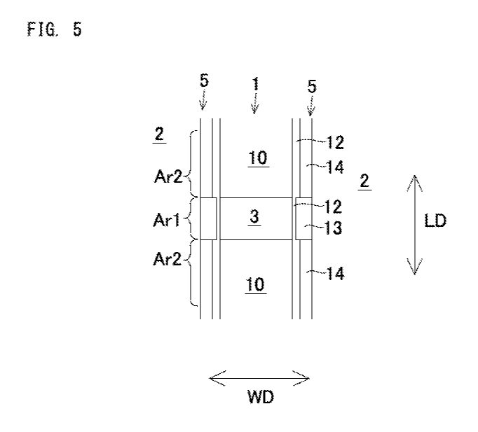

Below, a second embodiment in accordance with the present disclosure is described with reference to FIGS. 4 and 5.

As shown in FIG. 4, protrusion 3 is formed at circumferential groove 1 but no slit 4 is formed thereat. As shown in FIGS. 4 and 5, there are two edges 5 where contact patch 2 intersects the two groove sidewalls 11 at either side in the groove width direction WD of protrusion 3. As seen in plan view, groove sidewall 11 has first region Ar1 which is adjacent to protrusion 3, and second regions Ar2 which are present to either side in the groove long direction LD of first region Ar1. First chamfered region 13 serving as beveling of edge 5 is formed at first region Ar1, and second chamfered regions 14 serving as beveling of edge 5 are formed at second regions Ar2. So as to cause first chamfered region 13 to be more erect with respect to contact patch 2 than second chamfered region 14 is with respect thereto, the angle that first chamfered region 13 makes with contact patch 2 is larger than the angle that second chamfered region 14 makes with contact patch 2. In the drawing, angle α that first chamfered region 13 makes with contact patch 2 is larger than angle β that second chamfered region 14 makes with contact patch 2. As a result, presence of first chamfered region 13 causes edge 5 at first region Ar1 to be more relieved than edge 5 at second region Ar2.

It is preferred, at a sectional view of a section taken along the groove width direction WD of circumferential groove 1 (shown in FIG. 4), that the cross-sectional area S3 of the amount by which edge 5 is relieved at first region Ar1 by first chamfered region 13 be not less than the cross-sectional area S4 of protrusion 3. If this condition is satisfied, it will be possible for the amount of excess rubber produced due to relieving by the first chamfered region to be made available to compensate for any insufficiency in the amount of rubber for formation of the protrusion. But note that there will of course be occurrence of effect whereby trapped air is suppressed even when S3<S4.

Shape of circumferential groove 1 in the example of FIGS. 4 and 5 will now be described in further detail. Groove sidewall 11 at first region Ar1 and second region Ar2 has third wall face 12 which lies in the groove long direction LD at first region Ar1 and second region Ar2. At first region Ar1, first chamfered region 13 extends so as to be directed toward and intersect contact patch 2 from third wall face 12. Groove sidewall 11 at second region Ar2 has second chamfered region 14 which extends so as to be directed toward and intersect contact patch 2 from third wall face 12. As described above, so as to cause first chamfered region 13 to be more erect with respect to contact patch 2 than second chamfered region 14 is with respect thereto, the angle that first chamfered region 13 makes with contact patch 2 is larger than the angle that second chamfered region 14 makes with contact patch 2.

Note that while a first chamfered region 13 is formed on each of the two groove sidewalls 11 in the example shown in FIGS. 4 and 5, it is also possible for first chamfered region 13 to be formed on only one of the groove sidewalls 11.

### Third Embodiment

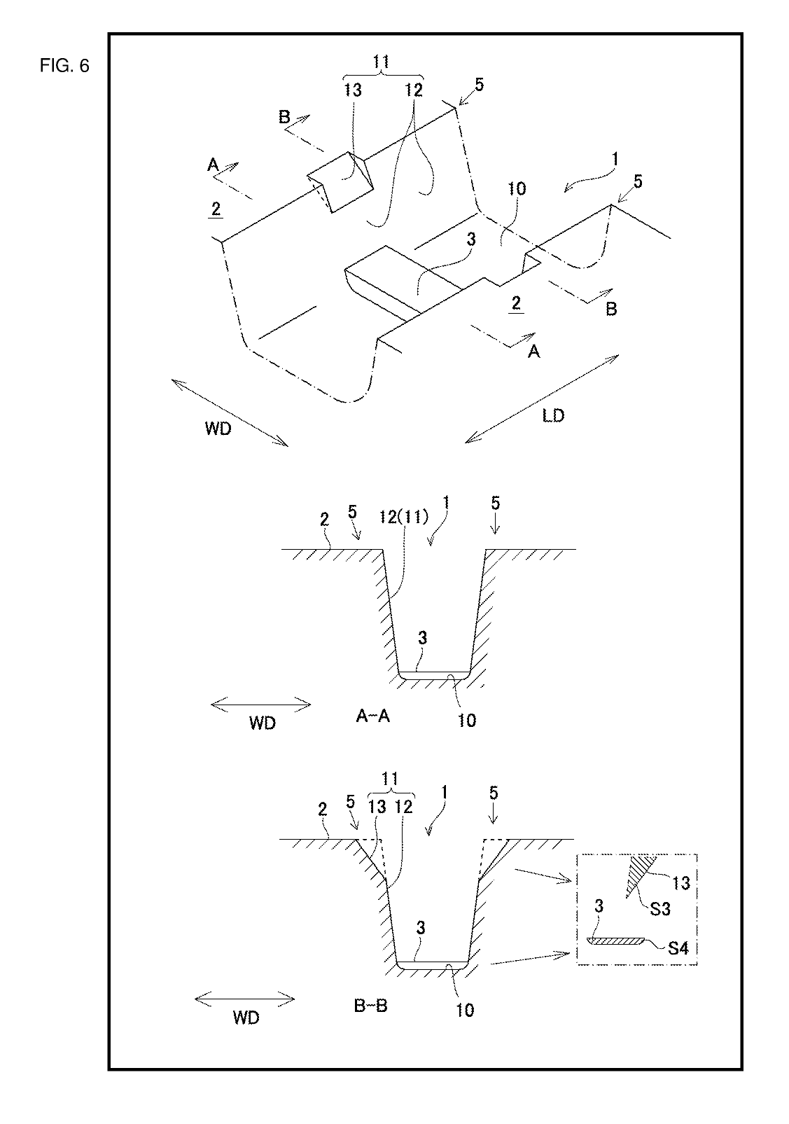

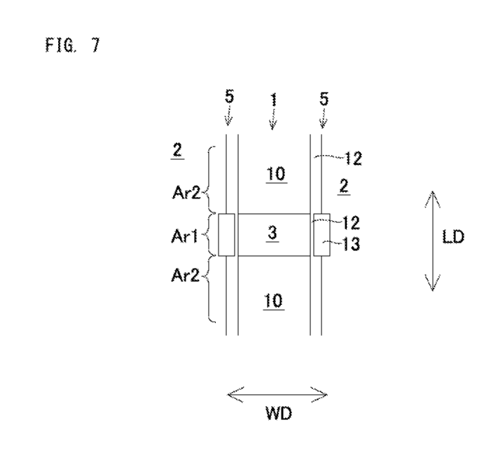

Below, a third embodiment in accordance with the present disclosure is described with reference to FIGS. 6 and 7.

As shown in FIG. 5, protrusion 3 is formed at circumferential groove 1 but no slit 4 is formed thereat. As shown in FIGS. 6 and 7, there are two edges 5 where contact patch 2 intersects the two groove sidewalls 11 at either side in the groove width direction WD of protrusion 3. As seen in plan view, groove sidewall 11 has first region Ar1 which is adjacent to protrusion 3, and second regions Ar2 which are present to either side in the groove long direction LD of first region Ar1. First chamfered region 13 serving as beveling of edge 5 is formed at first region Ar1. No chamfered region serving as beveling of edge 5 is formed at second region Ar2. Due to the fact that first chamfered region 13 serving as beveling of edge 5 is formed only at first region Ar1, presence of first chamfered region 13 causes edge 5 at first region Ar1 to be more relieved than edge 5 at second region Ar2.

It is preferred, at a sectional view of a section taken along the groove width direction WD of circumferential groove 1 (shown in FIG. 6), that the cross-sectional area S3 of the amount by which edge 5 is relieved at first region Ar1 by first chamfered region 13 be not less than the cross-sectional area S4 of protrusion 3. If this condition is satisfied, it will be possible for the amount of excess rubber produced due to relieving by the first chamfered region to be made available to compensate for any insufficiency in the amount of rubber for formation of the protrusion. But note that there will of course be occurrence of effect whereby trapped air is suppressed even when S3<S4.

Shape of circumferential groove 1 in the example of FIGS. 6 and 7 will now be described in further detail. Groove sidewall 11 at first region Ar1 and second region Ar2 has third wall face 12 which lies in the groove long direction LD at first region Ar1 and second region Ar2. At first region Ar1, first chamfered region 13 extends so as to be directed toward and intersect contact patch 2 from third wall face 12. At second region Ar2, third wall face 12 extends so as to be directed toward the shallow end of circumferential groove 1 and intersect contact patch 2.

Note that while a first chamfered region 13 is formed on each of the two groove sidewalls 11 in the example shown in FIGS. 6 and 7, it is also possible for first chamfered region 13 to be formed on only one of the groove sidewalls 11.

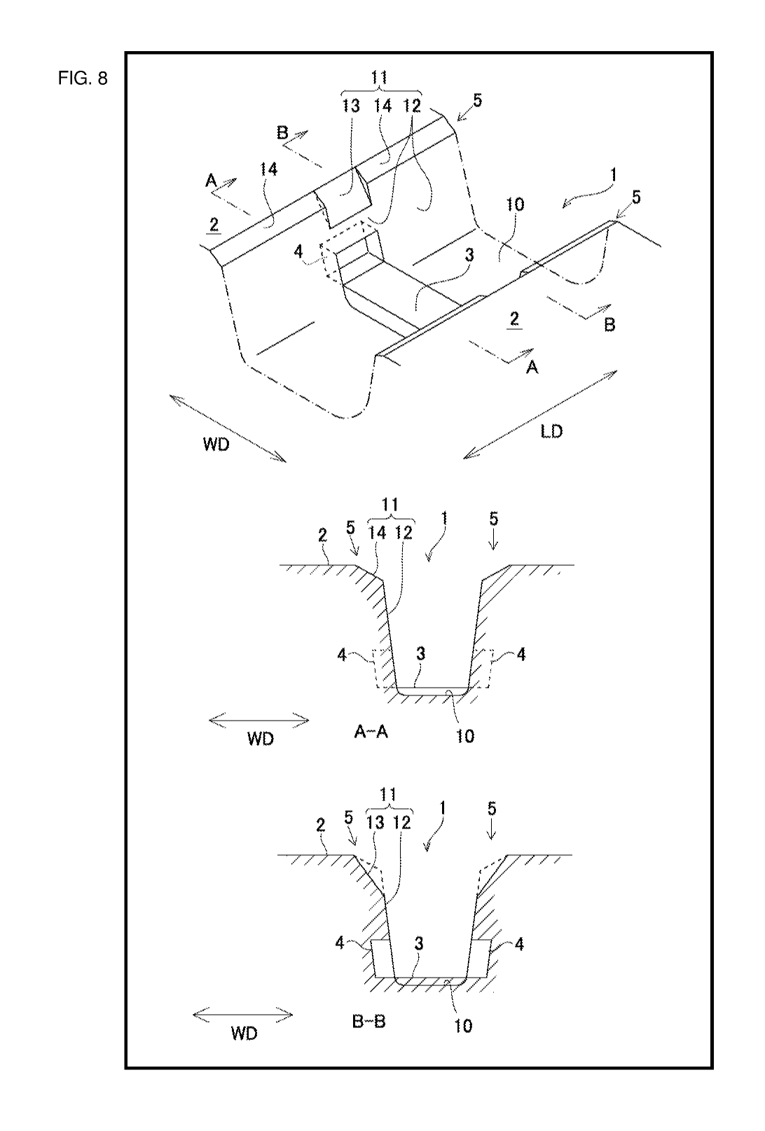

As shown in FIG. 8, the first embodiment and the second embodiment may be combined. Alternatively, the first embodiment and the third embodiment may be combined. In either case, the reason for doing so is that this will allow increase in the effect whereby occurrence of trapped air is reduced.

### Mold for Molding Tire

A mold for molding a tire which is for molding a pneumatic tire in accordance with the first embodiment has, at the tire molding surface thereof, mold convexities and concavities corresponding to at least circumferential groove 1, protrusion 3, and slit 4.

A mold for molding a tire which is for molding a pneumatic tire in accordance with the second or third embodiments has, at the tire molding surface thereof, mold convexities and concavities corresponding to at least circumferential groove 1, protrusion 3, and first chamfered region 13.

A mold for molding a tire which is for molding a pneumatic tire in accordance with the first and second, or the first and third, embodiments has, at the tire molding surface thereof, mold convexities and concavities corresponding to at least circumferential groove 1, protrusion 3, slit 4, and first chamfered region 13.

As described above, a pneumatic tire associated with the first embodiment has circumferential groove(s) 1 which extend in the tire circumferential direction and which partition contact patch 2, protrusion 3 which protrudes from base 10 of circumferential groove 1 and which interconnects two groove sidewalls 11 at either side in the groove width direction WD of protrusion 3, and a pair of mutually facing slits 4 which are formed at the groove sidewalls 11 of the circumferential groove 1. Slits 4 do not extend as far as contact patch 2, being closed at the interior of groove sidewalls 11. Length L1 in the groove long direction LD of slit 4 is not less than length L2 in the groove long direction LD of protrusion 3.

Thus, because formed at the two groove sidewalls 11 at either side in the groove width direction WD of protrusion 3 there are mutually facing slits 4 constituting a pair thereof, and because length L1 in the groove long direction LD of slit 4 is not less than length L2 in the groove long direction LD of protrusion 3, it is possible for excess rubber produced due to presence of slits 4 to be used for formation of protrusion 3, and it is possible to reduce occurrence of trapped air that might otherwise be present due to insufficiency in the amount of rubber at protrusion 3 itself and/or the region surrounding protrusion 3.

Moreover, because slits 4 do not extend as far as contact patch 2 but are closed at the interior of groove sidewalls 11, it is possible to avoid the situation in which the shape of contact patch 2 is altered and visual attractiveness is impaired such as might occur were slit(s) 4 to present opening(s) to contact patch 2.

In accordance with the first embodiment, at a sectional view of a section taken along the groove width direction WD of circumferential groove 1, the sum (S1×2) of the cross-sectional area S1 at each of the pair of slits 4 is not less than the cross-sectional area S2 of protrusion 3.

If this condition is satisfied, because the combined volume of the pair of slits will be not less than the volume of protrusion 3, and because the amount of excess rubber produced as a result of presence of slits 4 will exceed any insufficiency in the amount of rubber for formation of protrusion 3, it will be possible to supplement the filling of protrusion 3 with an adequate amount of rubber, and it will be possible to further reduce occurrence of trapped air at protrusion 3 itself due to insufficiency in the amount of rubber.

In accordance with the first embodiment, length D1 of slit 4 in the groove width direction WD of circumferential groove 1 increases as one proceeds from the shallow end of circumferential groove 1 to the deep end thereof.

Such a constitution will make it possible to decrease the tendency for occurrence of snagging on slit 4 during removal of the tire from the mold, and make it possible to decrease occurrence of cracking.

In accordance with the first embodiment, length L1 in the groove long direction LD of slit 4 is greater than length L2 in the groove long direction LD of protrusion 3.

Such a constitution will make it possible for length D1 of slit 4 in the groove width direction WD of circumferential groove 1 to be made short, making it possible to decrease the tendency for the tire to get stuck during removal from the mold, and making it possible to decrease occurrence of cracking. Moreover, because there is a tendency due to presence of slits 4 for the amount of excess rubber to increase beyond the amount of rubber needed to form protrusion 3, it will be possible to achieve further improvement in the effect whereby trapped air at protrusion 3 itself is reduced.

A pneumatic tire in accordance with the second or third embodiments has circumferential groove(s) 1 which extend in the tire circumferential direction and which partition contact patch 2, and protrusion 3 which protrudes from base 10 of circumferential groove 1 and which interconnects two groove sidewalls 11 at either side in the groove width direction WD of protrusion 3. As seen in plan view, at least one of the two groove sidewalls 11 has first region Ar1 which is adjacent to protrusion 3, second regions Ar2 which are present to either side in the groove long direction LD of first region Ar1, and first chamfered region 13 which serves as beveling and which is formed at first region Ar1. Presence of first chamfered region 13 causes edge 5 where contact patch 2 and groove sidewall 11 of first region Ar1 intersect to be more relieved than edge 5 where the contact patch and groove sidewall 11 of second region Ar2 intersect.

Thus, relieving by first chamfered region 13 serving as beveling makes it possible for the excess rubber to be used for formation of protrusion 3, and makes it possible to reduce occurrence of trapped air due to insufficiency in the amount of rubber at protrusion 3 itself and/or the region surrounding protrusion 3. Moreover, because first chamfered region 13 constitutes beveling of edge 5, contact patch shape being unaltered, it is possible to avoid impairment of visual attractiveness as compared with the situation that exists with slit(s) that present opening(s) to contact patch 2.

At the second or third embodiments, the cross-sectional area S3 of the amount by which edge 5 is relieved at first region Ar1 by first chamfered region 13 is not less than the cross-sectional area S4 of protrusion 3.

Such a constitution will make it possible for the amount of excess rubber produced due to relieving by first chamfered region 13 to be made available to compensate for any insufficiency in the amount of rubber for formation of protrusion 3, and will make it possible to reduce occurrence of trapped air due to insufficiency in the amount of rubber.

At the second embodiment, groove sidewall 11 at first region Ar1 and second region Ar2 has third wall face 12 which lies in the groove long direction LD at first region Ar1 and second region Ar2. At first region Ar1, first chamfered region 13 extends so as to be directed toward and intersect contact patch 2 from third wall face 12. Groove sidewall 11 at second region Ar2 has second chamfered region 14 which extends so as to be directed toward and intersect contact patch 2 from third wall face 12. To cause first chamfered region 13 to be more erect with respect to contact patch 2 than second chamfered region 14 is with respect thereto, the angle that first chamfered region 13 makes with contact patch 2 is larger than the angle that second chamfered region 14 makes with contact patch 2.

Such constitution makes it possible to achieve the effect whereby occurrence of trapped air is reduced due to presence of first chamfered region 13 in the context of a design in which beveling is provided everywhere along edge 5.

At the third embodiment, groove sidewall 11 at first region Ar1 and second region Ar2 has third wall face 12 which lies in the groove long direction LD at first region Ar1 and second region Ar2. At first region Ar1, first chamfered region 13 extends so as to be directed toward and intersect contact patch 2 from third wall face 12. At second region Ar2, third wall face 12 extends so as to be directed toward the shallow end of circumferential groove 1 and intersect contact patch 2.

Such constitution makes it possible to achieve the effect whereby occurrence of trapped air is reduced due to presence of first chamfered region 13 in the context of a design that is not predicated on beveling being provided everywhere along edge 5.

A mold for molding a tire which is for molding a pneumatic tire in accordance with any of the foregoing has, at the tire molding surface thereof mold convexities and concavities corresponding to circumferential groove 1, protrusion 3, and slit 4.

While embodiments in accordance with the present disclosure have been described above with reference to the drawings, it should be understood that the specific constitution thereof is not limited to these embodiments. The scope of the present disclosure is as indicated by the claims and not merely as described at the foregoing embodiments, and moreover includes all variations within the scope of or equivalent in meaning to that which is recited in the claims.

Structure employed at any of the foregoing embodiment(s) may be employed as desired at any other embodiment(s). The specific constitution of the various components is not limited only to the foregoing embodiment(s) but admits of any number of variations without departing from the gist of the present disclosure.

1. A pneumatic tire comprising:
a circumferential groove that extends in a tire circumferential direction and that partitions a contact patch; and
a protrusion that protrudes from a base of the circumferential groove and that interconnects two groove sidewalls at either side in a groove width direction of the protrusion;
wherein as seen in plan view, at least one of the two groove sidewalls at either side in the groove width direction of the protrusion has a first region that is adjacent to the protrusion, second regions that are present to either side in the groove long direction of the first region, and a first chamfered region that serves as beveling and that is formed at the first region, and
presence of the first chamfered region causes an edge where the contact patch and the groove sidewall of the first region intersect to be more relieved than an edge where the contact patch and the groove sidewall of the second region intersect.

2. The pneumatic tire according to claim 1 wherein a cross-sectional area of an amount by which the edge is relieved at the first region by the first chamfered region is not less than a cross-sectional area of the protrusion.

3. The pneumatic tire according to claim 1 wherein:
the groove sidewall at the first region and the second region has a third wall face that lies in the groove long direction at the first region and the second region;
at the first region, the first chamfered region extends so as to be directed toward and intersect the contact patch from the third wall face;
the groove sidewall at the second region has a second chamfered region that extends so as to be directed toward and intersect the contact patch the from third wall face; and
so as to cause the first chamfered region to be more erect with respect to the contact patch than the second chamfered region is with respect thereto, an angle that the first chamfered region makes with the contact patch is larger than an angle that the second chamfered region makes with the contact patch.

4. The pneumatic tire according to claim 1 wherein:
the groove sidewall at the first region and the second region has a third wall face that lies in the groove long direction at the first region and the second region;
at the first region, the first chamfered region extends so as to be directed toward and intersect the contact patch from the third wall face; and
at the second region, the third wall face extends so as to be directed toward a shallow end of the circumferential groove and intersect the contact patch.

5. The pneumatic tire according to claim 1 comprising:
a pair of mutually facing slits that are formed at the groove sidewalls of the circumferential groove;
wherein the slits do not extend as far as the contact patch, being closed at interiors of the groove sidewalls; and
a length in a groove long direction of the slits is not less than a length in the groove long direction of the protrusion.

6. The pneumatic tire according to claim 5 wherein, at a sectional view of a section taken along the groove width direction of the circumferential groove, a sum of cross-sectional areas of the pair of slits is not less than a cross-sectional area of the protrusion.

7. The pneumatic tire according to claim 5 wherein lengths of the slits in the groove width direction of the circumferential groove increase as one proceeds from a shallow end of the circumferential groove to a deep end thereof.

8. The pneumatic tire according to claim 5 wherein the length in the groove long direction of the slits is greater than the length in the groove long direction of the protrusion.

9. A mold for molding the pneumatic tire in accordance with claim 1, the mold for molding the pneumatic tire having, at a tire molding surface thereof mold convexities and concavities corresponding to the circumferential groove, the protrusion, and the slits.
